(19) United States
(12) Patent Application Publication
(10) Pub. No.: US 2026/0285347 A1
(43) Pub. Date: Sep. 24, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SEIJI SUZUKI, TOKYO (JP); SHOTARO HIRATA, TOKYO (JP); SHINICHI IRIYA, TOKYO (JP); KATSUJI MIYAZAWA, TOKYO (JP); SATOSHI AKAGAWA, TOKYO (JP)

(21) Appl. No.: 19/479,944

(22) PCT Filed: Apr. 19, 2024
(86) PCT No.: PCT/JP2024/015586

§ 371 Date: Oct. 29, 2025

(30) Foreign Application Priority Data
May 10, 2023 (JP) 2023-077720

(51) Int. Cl. B60W 50/14; B60W 30/095; B60W 50/00; G06F 3/16; G10K 11/178

(52) U.S. Cl. CPC B60W 50/14; B60W 30/0956; B60W 50/0097; G06F 3/165; G10K 11/17823; B60W 2050/143; B60W 2050/146; B60W 2554/402; B60W 2554/4041; B60W 2554/4044; B60W 2554/4045; B60W 2554/80; G10K 2210/1282

(57) ABSTRACT

The present technology relates to an information processing apparatus, an information processing method, and a program that enable information for avoiding danger to be presented more favorably to a user of a moving body such as a vehicle.

An information processing apparatus according to the present technology includes a prediction unit which predicts movement information indicating a future movement of an object around a moving body; a calculation unit which calculates a degree of danger of the object on the basis of the movement information; and a presentation control unit which controls, on the basis of the degree of danger, a notification sound that is presented to a user of the moving body and that corresponds to a type of the object. The present technology can be applied to, for example, a moving body such as a vehicle.

### TECHNICAL FIELD

The present technology relates to an information processing apparatus, an information processing method, and a program, and, more particularly, to an information processing apparatus, an information processing method, and a program that enable information for avoiding danger to be presented more favorably to a user of a moving body such as a vehicle.

### BACKGROUND ART

From the past, there has been proposed a technology that uses a sound image localization technology to localize a sound image of a warning sound such as a beep sound in a direction of an object that is present around a vehicle, to cause a user of the vehicle to recognize the direction of the object (see, for example, Patent Literature 1).

### CITATION LIST

### Patent Literature

Patent Literature 1: WO 2021/079975

### DISCLOSURE OF INVENTION

### Technical Problem

In the conventional technology, even when hearing the warning sound, the user is incapable of knowing a type of object that is present around the vehicle. In addition, in the conventional technology, there is a possibility that the user will be distracted by the continuous warning sound.

The present technology has been made in view of the circumstances as described above, and aims at enabling information for avoiding danger to be presented more favorably to a user of a moving body such as a vehicle.

### Solution to Problem

An information processing apparatus according to an aspect of the present technology includes a prediction unit which predicts movement information indicating a future movement of an object around a moving body; a calculation unit which calculates a degree of danger of the object on the basis of the movement information; and a presentation control unit which controls, on the basis of the degree of danger, a notification sound that is presented to a user of the moving body and that corresponds to a type of the object.

An information processing method according to an aspect of the present technology is performed by an information processing apparatus, the information processing method including predicting movement information indicating a future movement of an object around a moving body; calculating a degree of danger of the object on the basis of the movement information; and controlling, on the basis of the degree of danger, a notification sound that is presented to a user of the moving body and that corresponds to a type of the object.

A program according to an aspect of the present technology causes a computer to execute processing including predicting movement information indicating a future movement of an object around a moving body; calculating a degree of danger of the object on the basis of the movement information; and controlling, on the basis of the degree of danger, a notification sound that is presented to a user of the moving body and that corresponds to a type of the object.

According to the aspect of the present technology, the movement information indicating the future movement of the object around the moving body is predicted, the degree of danger of the object is calculated on the basis of the movement information, and the notification sound that is presented to the user of the moving body and that corresponds to the type of the object is controlled on the basis of the degree of danger.

### BRIEF DESCRIPTION OF DRAWINGS

FIG. 1 is a block diagram showing a configuration example of a vehicle control system.

FIG. 2 is a diagram showing an example of sensing areas.

FIG. 3 is a block diagram showing a configuration example of a vehicle control system to which the present technology is applied.

FIG. 4 is a flowchart illustrating processing performed by the vehicle control system.

FIG. 5 is a diagram showing an arrangement example of speakers.

FIG. 6 is a diagram showing another arrangement example of the speakers.

FIG. 7 is a diagram showing examples of outputting a notification sound.

FIG. 8 is a diagram showing an example of visual information.

FIG. 9 is a diagram showing another example of the visual information.

FIG. 10 is a block diagram showing a configuration example of hardware of a computer.

### MODES FOR CARRYING OUT THE INVENTION

Hereinafter, modes for carrying out the present technology will be described. Descriptions will be given in the following order.
1. Configuration example of vehicle control system
2. Embodiment
3. Modified examples

### 1. Configuration Example of Vehicle Control System

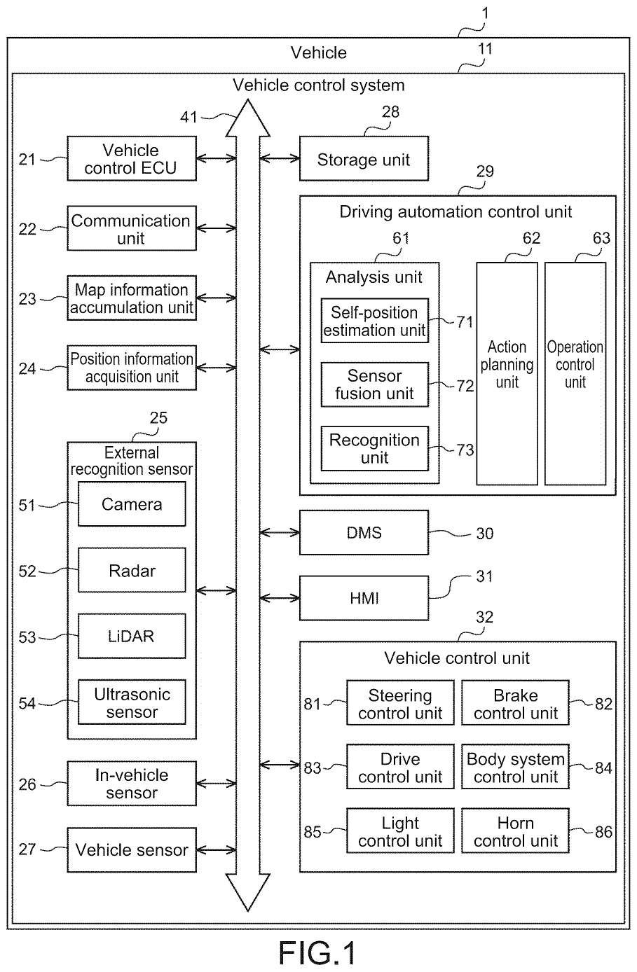

FIG. 1 is a block diagram showing a configuration example of a vehicle control system 11, which is an example of a mobile body control system to which the present technology is applied.

The vehicle control system 11 is provided in a vehicle 1 and performs processing related to driving automation of the vehicle 1. This driving automation includes driving automation of levels 1 to 5, and remote assistance and/or remote driving of the vehicle 1 by a remote driver.

The vehicle control system 11 includes a vehicle control ECU (Electronic Control Unit) 21, a communication unit 22, a map information accumulation unit 23, a position information acquisition unit 24, an external recognition sensor 25, an in-vehicle sensor 26, a vehicle sensor 27, a storage unit 28, a driving automation control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the driving automation control unit 29, the DMS 30, the HMI 31, and the vehicle control unit 32 are communicably connected to each other via a communication network 41. The communication network 41 includes, for example, an in-vehicle communication network, a bus, and/or the like compliant with a digital bidirectional communication standard such as a CAN (Controller Area Network), a LIN (Local Interconnect Network), a LAN (Local Area Network), FlexRay®, or Ethernet®. The communication network 41 may be selectively used according to the type of data to be transmitted. For example, the CAN may be used for data related to vehicle control, and the Ethernet may be used for large-volume data. It is noted that the respective units of the vehicle control system 11 may be connected not via the communication network 41 but directly via wireless communication that assumes communication at a relatively short distance, such as near field communication (NFC) and Bluetooth®.

It is noted that hereinafter, when the respective units of the vehicle control system 11 communicate with each other via the communication network 41, the communication network 41 will not be described. For example, when the vehicle control ECU 21 and the communication unit 22 communicate with each other via the communication network 41, it is simply described that the vehicle control ECU 21 and the communication unit 22 communicate with each other.

The vehicle control ECU 21 is implemented by, for example, various processors, such as a CPU (Central Processing Unit) and/or an MPU (Micro Processing Unit). The vehicle control ECU 21 controls all or a part of the functions of the vehicle control system 11.

The communication unit 22 communicates with various devices inside the vehicle and outside the vehicle, other vehicles, servers, base stations, and/or the like, to transmit and receive various types of data. At this time, the communication unit 22 can communicate using a plurality of communication technologies.

Communication that the communication unit 22 is capable of executing with devices outside the vehicle will be schematically described. The communication unit 22 communicates with a server or the like existing on an external network (hereinafter, will be referred to as an external server) via a base station or an access point by a wireless communication technology, the examples of which include 5G (5 th Generation Mobile Communication System), LTE (Long Term Evolution), DSRC (Dedicated Short Range Communications), and the like. The external network with which the communication unit 22 communicates is, for example, the Internet, a cloud network, a company-specific network, or the like. The communication technology used by the communication unit 22 to communicate with the external network is not particularly limited as long as it is a wireless communication technology that enables digital bidirectional communication at a communication speed equal to or more than a predetermined speed and at a distance equal to or more than a predetermined distance.

Further, for example, the communication unit 22 can communicate with terminals existing in the vicinity of the vehicle using a P2P (Peer To Peer) technology. The terminals existing in the vicinity of the vehicle include, for example, a terminal worn by a moving body moving at a relatively low speed, such as a pedestrian or a bicycle, a terminal installed at a fixed position in a store or the like, and/or an MTC (Machine Type Communication) terminal. In addition, the communication unit 22 can also perform V2X communication. V2X communication refers to communication between a vehicle and another entity, the examples of which include vehicle-to-vehicle communication with another vehicle, vehicle-to-infrastructure communication with a roadside device or the like, vehicle-to-home communication with a home, vehicle-to-pedestrian communication with a terminal or the like carried or worn by a pedestrian, and the like.

For example, the communication unit 22 can receive a program for updating software for controlling the operation of the vehicle control system 11 from outside (Over The Air). In addition, the communication unit 22 can receive map information, traffic information, information on surroundings of the vehicle 1, and/or the like from outside. Further, for example, the communication unit 22 can transmit information related to the vehicle 1, information on the surroundings of the vehicle 1, and/or the like to the outside. Examples of the information related to the vehicle 1 that is transmitted to the outside by the communication unit 22 include data indicating the state of the vehicle 1, a recognition result obtained by a recognition unit 73, and the like. Furthermore, the communication unit 22 performs communication that supports a vehicle emergency call system, an example of which is eCall.

For example, the communication unit 22 receives an electromagnetic wave transmitted by a road traffic information communication system (VICS (Vehicle Information and Communication System)®) using a radio wave beacon, an optical beacon, FM multiplex broadcasting, and/or the like.

The communication that the communication unit 22 is capable of executing with the in-vehicle devices will be schematically described. The communication unit 22 can communicate with the in-vehicle devices using wireless communication, for example. For example, the communication unit 22 can wirelessly communicate with an in-vehicle device by any wireless communication technology that enables digital bidirectional communication at a communication speed equal to or more than a predetermined speed, examples of the wireless communication technologies including wireless LAN, Bluetooth, NFC, and WUSB (Wireless USB). The communication unit 22 is not limited thereto, and the communication unit 22 can also communicate with the in-vehicle devices using wired communication. For example, the communication unit 22 can communicate with the in-vehicle devices by wired communication via a cable connected to a connection terminal (not shown). The communication unit 22 can communicate with the in-vehicle devices by any wired communication technology that enables digital bidirectional communication at a communication speed equal to or more than a predetermined speed, examples of the wired communication technologies including USB (Universal Serial Bus), HDMI (High-Definition Multimedia Interface)®, and MHL (Mobile High-definition Link).

Here, the in-vehicle devices with which the communication unit 22 communicates refer to, for example, devices that are not connected to the communication network 41 in the vehicle. Assumed as the in-vehicle devices are, for example, a mobile device or a wearable device carried by a user in the vehicle such as a driver, an information device brought in and temporarily installed in the vehicle, and the like.

The map information accumulation unit 23 accumulates a map acquired from outside and/or a map created by the vehicle 1. For example, the map information accumulation unit 23 accumulates a three-dimensional high-precision map, a global map having lower precision than the high-precision map and covering a wide area, and/or the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including a point cloud (point group data). The vector map is, for example, a map in which traffic information such as positions of lanes and/or traffic lights is associated with a point cloud map, for adaptation to driving automation.

The point cloud map and the vector map may be, for example, provided from an external server or the like, or may be created by the vehicle 1 as a map to be matched with a local map to be described later based on sensing results by a camera 51, a radar 52, a LiDAR 53, and the like, and may be accumulated in the map information accumulation unit 23. Furthermore, in a case where a high-precision map is provided from an external server or the like, for example, map data of several hundred square meters regarding a planned path on which the vehicle 1 is to travel is acquired from the external server or the like in order to reduce the amount of communication.

The position information acquisition unit 24 receives GNSS (Global Navigation Satellite System) signals from a GNSS satellite to acquire position information of the vehicle 1. The acquired position information is supplied to the driving automation control unit 29. It is noted that the position information acquisition unit 24 is not limited to using GNSS signals, and the position information may be acquired using a beacon, for example.

The external recognition sensor 25 includes various sensors used for recognizing a situation outside the vehicle 1, and supplies sensor data from the sensors to the respective units of the vehicle control system 11. The external recognition sensor 25 may include any type and any number of sensors.

For example, the external recognition sensor 25 may include the camera 51, the radar 52, the LiDAR (Light Detection and Ranging/Laser Imaging Detection and Ranging) 53, and an ultrasonic sensor 54. The external recognition sensor 25 is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

It is noted that the imaging method of the camera 51 is not particularly limited. For example, cameras that use various imaging methods with which distance measurement can be performed, such as a ToF (Time Of Flight) camera, a stereo camera, a monocular camera, and an infrared camera can be applied to the camera 51 as necessary. The camera 51 is not limited thereto and may be a camera for simply acquiring a captured image regardless of distance measurement.

Further, for example, the external recognition sensor 25 can include an environment sensor for detecting an environment with respect to the vehicle 1. The environment sensor is a sensor for detecting the environment such as a weather, a meteorological phenomenon, and brightness, and can include, for example, various sensors such as a rain drop sensor, a fog sensor, a sunshine sensor, a snow sensor, and an illuminance sensor.

In addition, for example, the external recognition sensor 25 includes a microphone used for detecting sound around the vehicle 1, a position of a sound source, and/or the like.

The in-vehicle sensor 26 includes various sensors for detecting information inside the vehicle, and supplies sensor data from the various sensors to the respective units of the vehicle control system 11. The type and number of the various sensors included in the in-vehicle sensor 26 are not particularly limited as long as the types and numbers allow practical installation of the sensors in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, for example, cameras that use various imaging methods with which distance measurement can be performed, such as a ToF camera, a stereo camera, a monocular camera, and an infrared camera, can be used. The camera included in the in-vehicle sensor 26 is not limited thereto, and the camera may be a camera for simply acquiring a captured image regardless of distance measurement. The biological sensor included in the in-vehicle sensor 26 is provided in, for example, a seat, a steering wheel, or the like, and detects various types of biological information of a user.

The vehicle sensor 27 includes various sensors for detecting the state of the vehicle 1, and supplies sensor data from the various sensors to the respective units of the vehicle control system 11. The type and number of the various sensors included in the vehicle sensor 27 are not particularly limited as long as the types and numbers allow practical installation of the sensors in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the rotation speed of an engine or a motor, an air pressure sensor that detects the air pressure of a tire, a slip rate sensor that detects the slip rate of a tire, and a wheel speed sensor that detects the rotation speed of a wheel. For example, the vehicle sensor 27 includes a battery sensor that detects a remaining amount and a temperature of a battery, and an impact sensor that detects an external impact.

The storage unit 28 includes at least one of a nonvolatile storage medium or a volatile storage medium, and stores data and a program. The storage unit 28 is used as, for example, an EEPROM (Electrically Erasable Programmable Read Only Memory) and a RAM (Random Access Memory), and a magnetic storage device such as an HDD (Hard Disc Drive), a semiconductor storage device, an optical storage device, and a magneto-optical storage device can be applied as the storage medium. The storage unit 28 stores various programs and data used by the respective units of the vehicle control system 11. For example, the storage unit 28 includes an EDR (Event Data Recorder) and/or a DSSAD (Data Storage System for Automated Driving), and stores information of the vehicle 1 before and after an event such as an accident and/or information acquired by the in-vehicle sensor 26.

The driving automation control unit 29 controls a driving automation function of the vehicle 1. For example, the driving automation control unit 29 includes an analysis unit 61, an action planning unit 62, and an operation control unit 63.

The analysis unit 61 performs analysis processing of the situation of the vehicle 1 and/or a situation around the vehicle 1. The analysis unit 61 includes a self-position estimation unit 71, a sensor fusion unit 72, and the recognition unit 73.

The self-position estimation unit 71 estimates the self-position of the vehicle 1 based on sensor data from the external recognition sensor 25 and a high-precision map accumulated in the map information accumulation unit 23. For example, the self-position estimation unit 71 estimates the self-position of the vehicle 1 by generating a local map based on sensor data from the external recognition sensor 25 and matching the local map with the high-precision map. As the position of the vehicle 1, for example, the center of the rear wheel pair axle is used as a reference.

For example, the local map is a three-dimensional high-precision map created using a technology such as SLAM (Simultaneous Localization and Mapping), an occupancy grid map, and/or the like. The three-dimensional high-precision map is, for example, the point cloud map described above or the like. The occupancy grid map is a map in which a three-dimensional or two-dimensional space around the vehicle 1 is divided into grids of a predetermined size, and an occupancy state of an object is indicated for each grid. The occupancy state of an object is indicated by, for example, the presence or absence or a presence probability of the object. The local map is also used for, for example, detection processing and recognition processing of a situation outside the vehicle 1 by the recognition unit 73.

It is noted that the self-position estimation unit 71 may estimate the self-position of the vehicle 1 based on the position information acquired by the position information acquisition unit 24 and the sensor data from the vehicle sensor 27.

The sensor fusion unit 72 performs sensor fusion processing of combining a plurality of different types of sensor data (for example, image data supplied from the camera 51 and sensor data supplied from the radar 52) to obtain information. Methods for combining different types of sensor data include composite, integration, fusion, association, and the like.

The recognition unit 73 performs detection processing of detecting a situation outside the vehicle 1 and recognition processing of recognizing a situation outside the vehicle 1.

For example, the recognition unit 73 performs the detection processing and the recognition processing of a situation outside the vehicle 1 based on information from the external recognition sensor 25, information from the self-position estimation unit 71, information from the sensor fusion unit 72, and/or the like.

Specifically, for example, the recognition unit 73 performs the detection processing, the recognition processing, and/or the like of an object around the vehicle 1. The detection processing of an object is, for example, processing of detecting the presence or absence, size, shape, position, movement (for example, a content of an operation, a movement direction, and a movement speed), and/or the like of an object. The recognition processing of an object is, for example, processing of recognizing an attribute such as a type of an object and/or identifying a specific object. The detection processing and the recognition processing are not necessarily divided clearly, and may be duplicative.

For example, the recognition unit 73 detects an object around the vehicle 1 by performing clustering to classify a point cloud that is based on sensor data from the radar 52, the LiDAR 53, or the like into clusters of point groups. Accordingly, the presence or absence, size, shape, and/or position of an object around the vehicle 1 are detected.

For example, the recognition unit 73 detects the movement of an object around the vehicle 1 by tracking the movement of the clusters of point groups classified by clustering. Accordingly, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and/or the like based on the image data supplied from the camera 51. Further, the recognition unit 73 recognizes the type of an object around the vehicle 1 by performing recognition processing such as semantic segmentation.

For example, the recognition unit 73 can perform recognition processing of traffic rules around the vehicle 1 based on a map accumulated in the map information accumulation unit 23, an estimation result of the self-position by the self-position estimation unit 71, and a recognition result of an object around the vehicle 1 by the recognition unit 73. Through this processing, the recognition unit 73 can recognize the position and state of a traffic light, the contents of a traffic sign and a road sign, the contents of a traffic regulation, a travelable lane, and/or the like.

For example, the recognition unit 73 can perform recognition processing of the environment around the vehicle 1. A weather, a temperature, a humidity, brightness, a state of the road surface, and the like are assumed as the surrounding environment to be recognized by the recognition unit 73.

The action planning unit 62 creates an action plan of the vehicle 1. For example, the action planning unit 62 creates an action plan by performing processing of path planning and path following.

It is noted that the path planning includes global path planning and local path planning. The global path planning includes processing of planning a rough path from the start to the goal. The local path planning, which is also referred to as trajectory planning, includes processing of generating a trajectory in the vicinity of the vehicle 1 through which the vehicle 1 can safely and smoothly travel along the planned path given the motion characteristics of the vehicle 1.

The path following is processing of planning an operation for safe and accurate traveling on a path planned by the path planning within a planned time. For example, the action planning unit 62 can calculate a target speed and a target angular velocity of the vehicle 1 based on a result of this path following processing.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, to perform lateral vehicle motion control and longitudinal vehicle motion control such that the vehicle 1 travels on the trajectory calculated by the trajectory planning. For example, the operation control unit 63 performs control for the purpose of: driver assistance functions such as collision avoidance or impact mitigation, inter-vehicle distance control, vehicle speed control, vehicle collision warning, and lane departure warning; and driving automation for traveling without operation of a driver or a remote driver.

The DMS 30 performs authentication processing of the driver, recognition processing of the state of the driver, and/or the like based on sensor data from the in-vehicle sensor 26, input data input to the HMI 31 to be described later, and/or the like. Examples of the state of the driver to be recognized include a physical condition, an arousal level, a concentration level, a fatigue level, a line-of-sight direction, a drunkenness level, a driving operation, a posture, and the like.

It is noted that the DMS 30 may perform authentication processing of a user other than the driver and recognition processing of the state of the user. Further, for example, the DMS 30 may perform recognition processing of a situation inside the vehicle based on sensor data from the in-vehicle sensor 26. Examples of the situation inside the vehicle to be recognized include a temperature, a humidity, brightness, odor, and the like.

The HMI 31 receives various types of data, instructions, and the like as an input and presents various types of data to a user.

The data input to the HMI 31 will be schematically described. The HMI 31 includes an input device used by a person to input data. The HMI 31 generates an input signal based on the data, instruction, and/or the like input by the input device, and supplies the input signal to the respective units of the vehicle control system 11. The HMI 31 includes, for example, an operation element such as a touch panel, a button, a switch, and/or a lever as the input device. The HMI 31 is not limited thereto and may further include an input device that enables information to be input by a method other than a manual operation, such as voice, gesture, and/or the like. In addition, the HMI 31 may use, for example, a remote control device that uses infrared rays or radio waves and/or an external connection device such as a mobile device and a wearable device adaptive to the operation of the vehicle control system 11, as an input device.

Presentation of data by the HMI 31 will be schematically described. The HMI 31 generates visual information, auditory information, and tactile information for the user or for the outside of the vehicle. Furthermore, the HMI 31 performs output control for controlling an output, an output content, an output timing, an output method, and/or the like for each piece of generated information. As the visual information, the HMI 31 generates and outputs, for example, an operation screen, a state display of the vehicle 1, a warning display, an image such as a monitor image indicating a situation around the vehicle 1, and information indicated by light. Further, as the auditory information, the HMI 31 generates and outputs, for example, information indicated by sound, such as voice guidance, a warning sound, and a warning message. Furthermore, as the tactile information, the HMI 31 generates and outputs, for example, information given to the tactile sense of a user by force, vibration, movement, and/or the like.

As the output device to which the HMI 31 outputs the visual information, for example, a display device that presents the visual information by displaying an image by itself and/or a projector device that presents the visual information by projecting an image can be applied. It is noted that the display device may be, for example, a head-up display, a transmissive display, or a display having an AR (Augmented Reality) function, in addition to the display device including a normal display. The display device may alternatively be a device that displays visual information in the field of view of a user, such as a wearable device having the AR function. The wearable device includes a glasses-type display, a smartphone, a smart watch, and the like. In addition, a display device included in a navigation device, an instrument panel, a CMS (Camera Monitoring System), an electronic mirror, a lamp, and/or the like provided in the vehicle 1 can also be used as the output device to which the HMI 31 outputs visual information. Furthermore, a retrofit display device such as an on-dash monitor, a tablet terminal, a drive recorder, and a display for a drive recorder can also be used as the output device to which the HMI 131 outputs visual information.

The output device to which the auditory information is output is provided on a front surface of a dashboard in front of the driver's seat or a passenger's seat, in a console provided between the driver's seat and the passenger's seat, on a windshield, a steering wheel, a back surface of the driver's seat or the passenger's seat, and/or the like.

As the output device to which the HMI 31 outputs the auditory information, for example, an audio speaker, a headphone, and/or an earphone can be applied.

As the output device to which the HMI 31 outputs the tactile information, for example, a haptic element that uses a haptic technology can be applied. The haptic element is provided at, for example, a portion where the user touches, such as a steering wheel or a seat. It is noted that the tactile information may be output by a smartphone, a smartwatch, and/or the like carried by the user.

The vehicle control unit 32 controls the respective units of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and/or the like of the state of the steering system of the vehicle 1. The steering system includes, for example, a steering mechanism including a steering wheel and the like, an electric power steering, and/or the like. The steering control unit 81 includes, for example, a steering ECU that controls the steering system, an actuator that drives the steering system, and/or the like.

The brake control unit 82 performs detection, control, and/or the like of the state of the brake system of the vehicle 1. The brake system includes, for example, a brake mechanism including a brake pedal and the like, an ABS (Antilock Brake System), a regenerative brake mechanism, and/or the like. The brake control unit 82 includes, for example, a brake ECU that controls the brake system, an actuator that drives the brake system, and/or the like.

The drive control unit 83 performs detection, control, and/or the like of the state of the drive system of the vehicle 1. The drive system includes, for example, an accelerator pedal, a driving force generation device for generating a driving force for an internal combustion engine, a driving motor, or the like, a driving force transmission mechanism for transmitting the driving force to the wheels, and/or the like. The drive control unit 83 includes, for example, a drive ECU that controls the drive system, an actuator that drives the drive system, and/or the like.

The body system control unit 84 performs detection, control, and/or the like of the state of the body system of the vehicle 1. The body system includes, for example, a keyless entry system, a smart key system, a power window device, a power seat, an air conditioner, an airbag, a seat belt, a shift lever, and/or the like. The body system control unit 84 includes, for example, a body system ECU that controls the body system, an actuator that drives the body system, and/or the like.

The light control unit 85 performs detection, control, and/or the like of the states of various lights of the vehicle 1. Examples of the light to be controlled by the light control unit 85 include a headlight, a backlight, a fog light, a turn signal, a brake light, a projector light, a display of a bumper, and the like. The light control unit 85 includes a light ECU that controls a light, an actuator that drives the light, and/or the like.

The horn control unit 86 performs detection, control, and/or the like of the state of the car horn of the vehicle 1. The horn control unit 86 includes, for example, a horn ECU that controls the car horn, an actuator that drives the car horn, and/or the like.

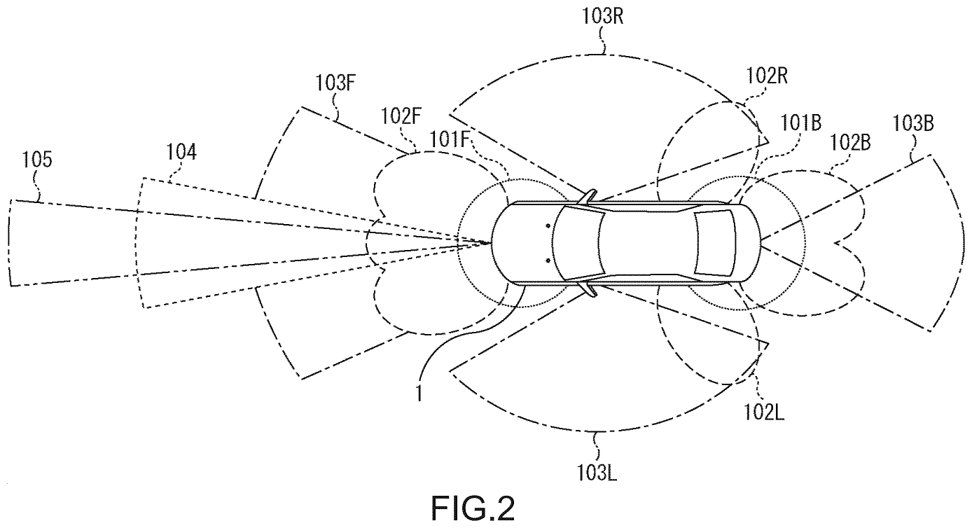

FIG. 2 is a diagram showing an example of sensing areas of the camera 51, the radar 52, the LiDAR 53, the ultrasonic sensor 54, and the like of the external recognition sensor 25 in FIG. 1. It is noted that FIG. 2 schematically shows the vehicle 1 as viewed from above, with the left end side being the front end (front) side of the vehicle 1 and the right end side being the rear end (rear) side of the vehicle 1.

A sensing area 101F and a sensing area 101B are examples of the sensing areas of the ultrasonic sensor 54. The sensing area 101F covers the periphery of the front end of the vehicle 1 by the plurality of the ultrasonic sensors 54. The sensing area 101B covers the periphery of the rear end of the vehicle 1 by the plurality of the ultrasonic sensors 54.

The sensing results in the sensing area 101F and the sensing area 101B are used in, for example, parking assistance of the vehicle 1, and the like.

A sensing area 102F, a sensing area 102B, a sensing area 102L, and a sensing area 102R indicate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. The sensing area 102L covers the rear periphery of the left side of the vehicle 1. The sensing area 102R covers the rear periphery of the right side of the vehicle 1.

The sensing result in the sensing area 102F is used in, for example, detection or the like of a vehicle, a pedestrian, or the like that is present on the front side of the vehicle 1. The sensing result in the sensing area 102B is used in, for example, a collision prevention function or the like on the rear side of the vehicle 1. The sensing results in the sensing area 102L and the sensing area 102R are used in, for example, detection or the like of an object in blind spots on sides of the vehicle 1.

A sensing area 103F, a sensing area 103B, a sensing area 103L, and a sensing area 103R indicate examples of sensing areas of the camera 51. The sensing area 103F covers a position farther than the sensing area 102F in front of the vehicle 1. The sensing area 103B covers a position farther than the sensing area 102B behind the vehicle 1. The sensing area 103L covers the periphery of the left side of the vehicle 1. The sensing area 103R covers the periphery of the right side of the vehicle 1.

The sensing result in the sensing area 103F can be used in, for example, recognition of a traffic light and/or a traffic sign, a lane departure prevention assist system, and/or an automatic headlight control system. The sensing result in the sensing area 103B can be used in, for example, parking assistance and/or a surround view system. The sensing results in the sensing area 103L and the sensing area 103R can be used in, for example, a surround view system.

A sensing area 104 indicates an example of a sensing area of the LiDAR 53. The sensing area 104 covers a position farther than the sensing area 103F in front of the vehicle 1. On the other hand, the sensing area 104 has a narrower range in the left-right direction than the sensing area 103F.

The sensing result in the sensing area 104 is used in, for example, detecting an object such as a peripheral vehicle.

A sensing area 105 indicates an example of the sensing area of the radar 52 for a long distance. The sensing area 105 covers a position farther than the sensing area 104 in front of the vehicle 1. On the other hand, the sensing area 105 has a narrower range in the left-right direction than the sensing area 104.

The sensing result in the sensing area 105 is used in, for example, ACC (Adaptive Cruise Control), emergency braking, collision avoidance, and/or the like.

It is noted that the sensing areas of the sensors including the cameras 51, the radar 52, the LiDAR 53, and the ultrasonic sensor 54 included in the external recognition sensor 25 may take various configurations other than those shown in FIG. 2.

Specifically, the ultrasonic sensors 54 may also sense the sides of the vehicle 1, and the LiDAR 53 may sense the rear of the vehicle 1. The installation positions of the sensors are not limited to the examples described above. In addition, the number of sensors may be one or more.

### 2. Embodiment

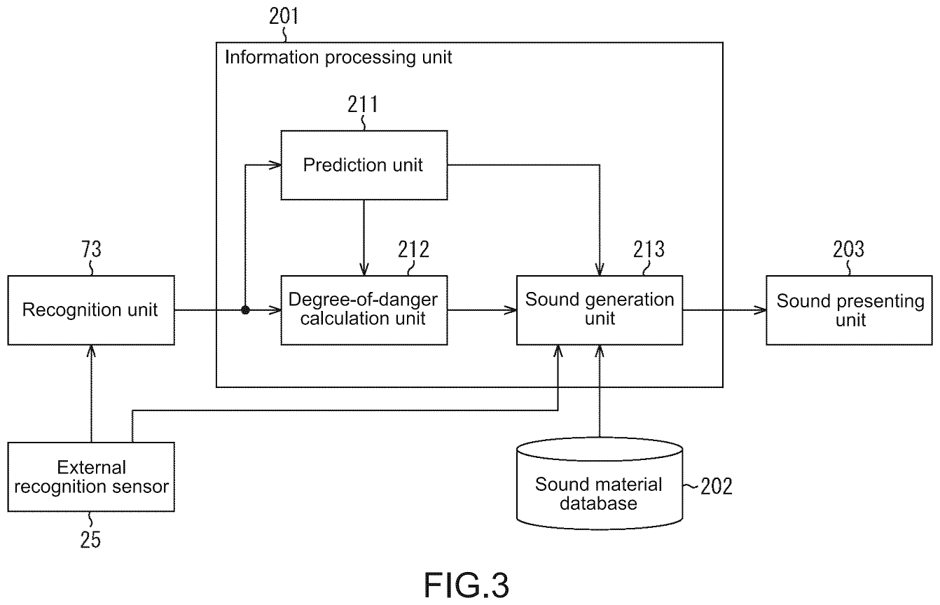

Next, an embodiment of the present technology will be described with reference to FIGS. 3 to 7.

FIG. 3 is a block diagram showing a configuration example of the vehicle control system 11 to which the present technology is applied.

The vehicle control system 11 shown in FIG. 3 includes, as well as the configuration described above (the external recognition sensor 25 and the recognition unit 73), an information processing unit 201 that calculates the degree of danger of an object around the vehicle 1 and generates audio data of a notification sound indicating the degree of danger of the object, a sound material database 202, and a sound presenting unit 203 that presents the notification sound. It is noted that FIG. 3 shows a configuration of a portion of the vehicle control system 11 that is related to the presentation of the notification sound.

The external recognition sensor 25 includes a plurality of microphones arranged so as to encompass the vehicle 1 at an outer edge portion of the vehicle 1, for example, similar to the camera 51, the radar 52, the LiDAR 53, the ultrasonic sensor 54, and the like. It is noted that the external recognition sensor 25 may include a microphone array including a plurality of microphones. The external recognition sensor 25 can collect sounds around the vehicle 1 while separating them according to arrival directions of the sounds using the plurality of microphones.

As described above, the recognition unit 73 acquires sensor data from the external recognition sensor 25, and performs the recognition processing of an object around the vehicle 1 based on the sensor data using AI (Artificial Intelligence) learned by using deep learning or other machine learning, a neural network, and/or the like. The recognition unit 73 recognizes, for example, the type, the attribute, the state, the position, the orientation, the speed, and the size of an object around the vehicle 1 by the recognition processing.

The type of object indicates whether the object is a pedestrian, a vehicle, a ball, a guardrail, a road sign, an obstacle, or the like. The recognition unit 73 recognizes not only the moving objects such as a pedestrian, a vehicle, and a ball, but also stationary objects such as a guardrail, a sign, and an obstacle.

When the type of object is a pedestrian, the attribute of the object indicates whether the pedestrian is a child, an elderly person, and/or the like. When the type of object is a vehicle, the attribute of the object indicates a type, color, and/or the like of the vehicle. The state of the object indicates a state where a pedestrian corresponding to an object is walking while looking at a smartphone, a state where the brake light of the vehicle as an object is on, and/or the like.

The recognition unit 73 supplies the recognition result of the object around the vehicle 1 to the information processing unit 201. It is noted that the recognition unit 73 may acquire information related to the object around the vehicle 1 from equipment other than the vehicle 1 via the communication unit 22, and perform the recognition processing based on that information.

The information processing unit 201 is a part of the function of the HMI 31. The information processing unit 201 includes a prediction unit 211, a degree-of-danger calculation unit 212, and a sound generation unit 213.

The prediction unit 211 predicts a future movement of an object around the vehicle 1 and a movement of the object in a case where an accident occurs, based on the recognition result of the object obtained by the recognition unit 73.

Specifically, the prediction unit 211 predicts a range that the object will reach in a few seconds at normal times as the future movement of the object. The range that the object will reach in a few seconds at normal times is basically predicted based on the position, the orientation, and the speed of the object.

It is noted that the range that the object will reach in a few seconds at normal times may alternatively be predicted based on the movement of the object in time series. For example, the range that the object will reach in a few seconds at normal times is predicted based on the movement amount of the object during a most-recent predetermined period. Alternatively, the range that the object will reach in a few seconds at normal times may be predicted in consideration of the state of the object, such as a state where a pedestrian is walking while looking at a smartphone or a state where a brake light of a vehicle is on.

For example, the prediction unit 211 predicts the possibility (probability) of an accident occurring and the movement of an object in a case where an accident occurs (the range that the object will reach in a few seconds), based on the attribute of the object such as “children are highly likely to suddenly run out onto the road” or “elderly people are highly likely to fall over while crossing the road”. The prediction unit 211 can also predict the possibility of an accident occurring and the movement of an object in a case where an accident occurs, in consideration of a position of a stationary object, such as “children are unlikely to suddenly run out onto the road because of the guardrail”.

The prediction unit 211 supplies movement information indicating the future movement of the object and accident information indicating the movement of the object in a case where an accident occurs to the degree-of-danger calculation unit 212 and the sound generation unit 213. The accident information includes information indicating the possibility of an accident occurring. The accident information may alternatively include prediction difficulty, which is a degree of difficulty in predicting the future movement of the object.

The degree-of-danger calculation unit 212 calculates the degree of danger of the object based on the recognition result of the object obtained by the recognition unit 73 and the movement information and accident information supplied from the prediction unit 211. For example, the possibility of a collision between the object and the vehicle 1 is estimated as the degree of danger based on the range that the object is predicted to reach in a few seconds and the movement direction and speed of the vehicle 1.

The degree-of-danger calculation unit 212 supplies the degree of danger of the object to the sound generation unit 213.

The sound generation unit 213 generates audio data of the notification sound based on the movement information and accident information supplied from the prediction unit 211 and the degree of danger of the object supplied from the degree-of-danger calculation unit 212.

Since the position of the object is recognized by the recognition unit 73, the sound generation unit 213 basically acquires a sound coming from the position of the object (the direction in which the object is present as viewed from the vehicle 1) from the external recognition sensor 25. When the object is an automobile, for example, the engine sound is acquired, when the object is a pedestrian, for example, the sound of footsteps is acquired, and when the object is a bicycle, for example, the sound of a chain is acquired.

The sound generation unit 213 causes the sound presenting unit 203 to output the sound coming from the position of the object (a sound actually emitted from the object) as the notification sound.

When the object is an electric vehicle or a pedestrian, the engine sound or sound of footsteps emitted from the electric vehicle or the pedestrian is not acquired in some cases because the volume of these sounds is low. Further, when the object is a ball, a sound is hardly emitted from the ball in actuality. Thus, for example, the sound of the ball rolling is not acquired in some cases. When the sound emitted from the object around the vehicle 1 is not acquired, the sound generation unit 213 generates audio data of a sound that evokes the type of the object based on audio data of the sound provided in advance, that has been acquired from the sound material database 202.

The generated audio data includes a “honking” sound that evokes a car horn of an automobile, a “roaring” sound that evokes an engine sound of a motorbike, a “tinkling” sound that evokes a bell sound of a bicycle, a “walking” sound that evokes a pedestrian, a “rolling” sound that evokes a ball, and the like. For example, the sound evoking an automobile may be a sound obtained by recording a sound emitted from the automobile in advance, may be a sound obtained by recording a sound emitted from another object in advance, or may be an electronic sound.

The sound generation unit 213 causes a sound that evokes a type of the object to be output from the sound presenting unit 203 as the notification sound. In this manner, the sound generation unit 213 functions as a presentation control unit that controls the sound presenting unit 203 to present the notification sound to the user of the vehicle 1.

Based on the degree of danger of the object, the sound generation unit 213 controls the volume of the notification sound for notifying of the object. For example, the sound generation unit 213 sets, to be high, the volume of the notification sound for notifying of an object having a degree of danger having a value larger than a first threshold value, and sets, to be low, the volume of the notification sound for notifying of an object having a degree of danger having a value smaller than the first threshold value.

It is noted that when the degree of danger has a value larger than a second threshold value (second threshold value >first threshold value), a warning sound such as a beep sound may be synthesized with a sound actually emitted from the object or a sound that evokes the type of object, and this synthesized sound may be output as the notification sound.

Further, as will be described later, the sound generation unit 213 controls a position of a sound image (virtual sound source) of the notification sound based on the position of the object.

Audio data of various sounds that evoke different types of objects is recorded in advance in the sound material database 202.

The sound presenting unit 203 includes, for example, a plurality of speakers installed in the vehicle. The sound presenting unit 203 outputs a notification sound under control of the sound generation unit 213, to present the notification sound to the user of the vehicle 1.

All or some of the functions of the recognition unit 73 and the information processing unit 201 may be provided in a device other than the vehicle 1, such as a cloud.

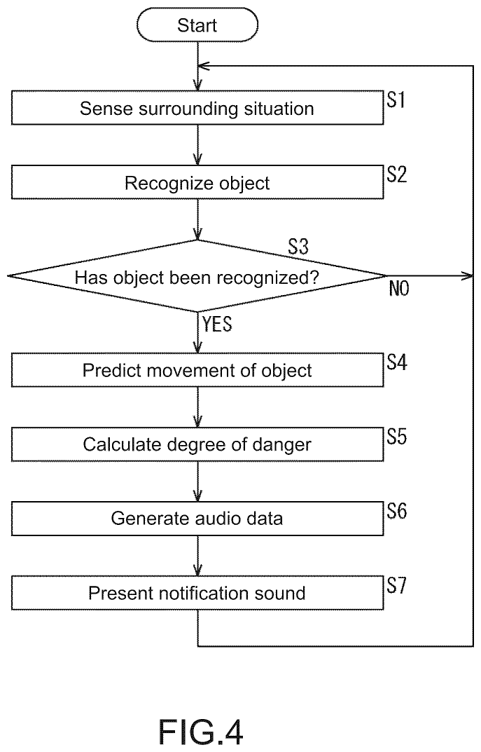

Next, processing performed by the vehicle control system 11 having the configuration as described above will be described with reference to the flowchart shown in FIG. 4. For example, the processing shown in FIG. 4 is started when an operation for activating the vehicle 1 to start driving is performed, that is, for example, when an ignition switch, a power switch, a start switch, or the like of the vehicle 1 is turned on. Further, for example, the processing shown in FIG. 4 is ended when an operation for ending the driving of the vehicle 1 is performed, that is, for example, when the ignition switch, the power switch, the start switch, or the like of the vehicle 1 is turned off.

In Step S1, the external recognition sensor 25 senses a situation around the vehicle 1.

In Step S2, the recognition unit 73 recognizes an object around the vehicle 1 based on the sensor data of the external recognition sensor.

In Step S3, the information processing unit 201 determines whether the recognition unit 73 has recognized an object.

When it is determined in Step S3 that an object has not been recognized, the processing returns to Step S1, and the situation around the vehicle 1 is sensed until an object is recognized.

On the other hand, when it is determined in Step S3 that an object has been recognized, the processing proceeds to Step S4. In Step S4, the prediction unit 211 predicts a future movement of the object recognized by the recognition unit 73.

In Step S5, the degree-of-danger calculation unit 212 calculates the degree of danger of the object recognized by the recognition unit 73 based on the recognition result obtained by the recognition unit 73 and the prediction result obtained by the prediction unit 211.

In Step S6, the sound generation unit 213 generates audio data of the notification sound based on the degree of danger.

In Step S7, the sound presenting unit 203 presents the notification sound to the user of the vehicle 1 under control of the sound generation unit 213. After the notification sound is presented in Step S7, the processing returns to Step S1, and the subsequent processing is performed.

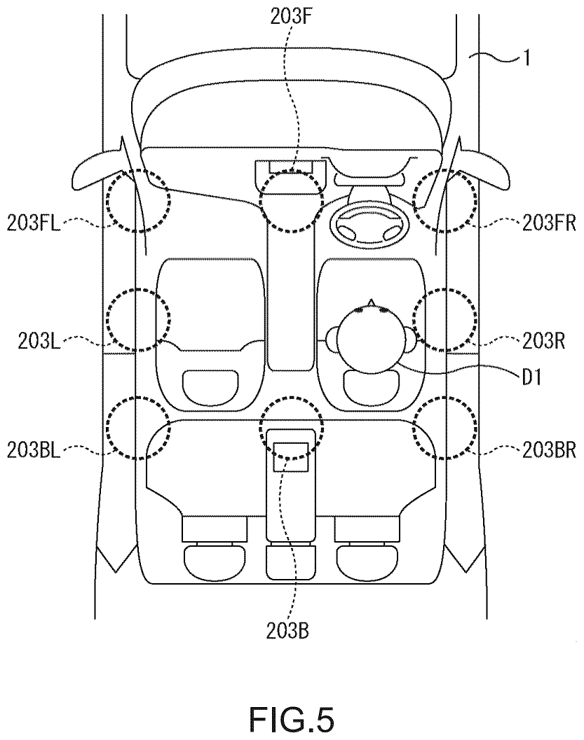

FIG. 5 is a diagram showing an arrangement example of speakers.

For example, the sound presenting unit 203 includes eight speakers 203F to 203B. It is noted that in FIG. 5, the positions of the speakers 203F to 203B are schematically indicated by circles in dotted lines.

The speakers 203F to 203B are arranged inside the vehicle 1 so as to surround the driver Dl sitting in the driver's seat.

Specifically, the speaker 203FL is arranged at the front left of the driver D1 near the front end of the door of the passenger's seat of the vehicle 1, and the speaker 203FR is arranged at the front right of the driver Dl near the front end of the door of the driver's seat of the vehicle 1. The speaker 203F is arranged near an intermediate point between the speaker 203FL and the speaker 203FR and also near the center of the dashboard of the vehicle 1.

The speaker 203BL is positioned at the rear left of the driver Dl at a position slightly forward from the center of the door of the left-side backseat of the vehicle 1, and the speaker 203BR is positioned at the rear right of the driver Dl at a position slightly forward from the center of the door of the right-side backseat of the vehicle 1.

The speaker 203L is arranged near an intermediate point between the speaker 203FL and the speaker 203BL and also near the rear end of the door of the passenger's seat of the vehicle 1. The speaker 203R is arranged near an intermediate point between the speaker 203FR and the speaker 203BR and also near the rear end of the door of the driver's seat of the vehicle 1.

The speaker 203B is arranged near an intermediate point between the speaker 203BL and the speaker 203BR and also near the center of the backseat. The speakers 203F and 203B and the speakers 203L and 203R are arranged so as to respectively oppose each other. The speakers 203F to 203B are all installed to face inwardly toward the inside of the vehicle 1.

The speakers 203F to 203B are used, for example, to output sounds directed entirely toward the inside of the vehicle (all passengers in the vehicle). The speakers 203F to 203B realize 360 Reality Audio® (hereinafter, will be referred to as 360RA) and stereophonic sound.

Here, 360RA is a technology in which sound images (virtual sound sources) of sounds are individually arranged at arbitrary positions in a spherical space, and outputs of the sounds are controlled so that a listener feels that the sounds are emitted from respective directions of the sound images. By presenting the notification sound using 360RA, for example, it is possible to cause the passenger to recognize the position of an object present around the vehicle 1 (the direction of the object as viewed from the vehicle 1).

It is noted that the number and positions of the speakers arranged in the vehicle 1 are not limited to the number and positions described with reference to FIG. 5. For example, the stereophonic sound may be realized by stereo speakers or nine or less surround speakers. The present technology can also be applied to a system that is capable of localizing a sound image only at an arbitrary position within a predetermined range instead of all directions. The stereophonic sound may be realized by a single speaker, or the present technology may be applied to a vehicle provided with a single speaker that does not support the stereophonic sound.

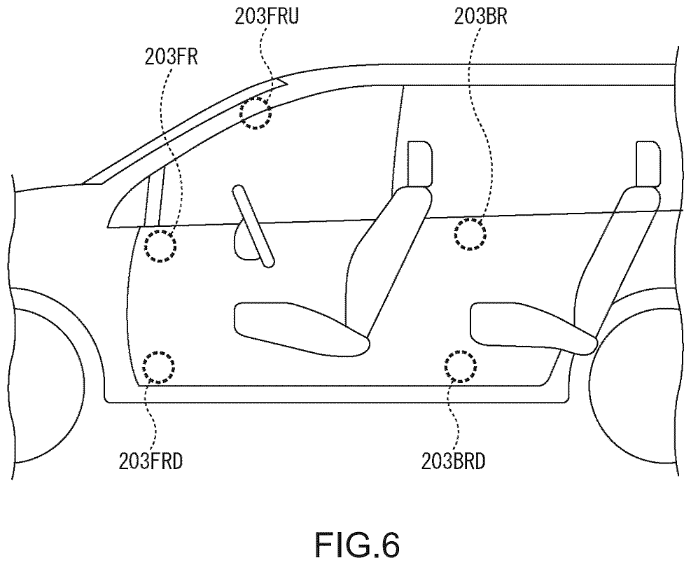

FIG. 6 is a diagram showing another arrangement example of the speakers.

As shown in FIG. 6, a plurality of speakers may be arranged at different heights. It is noted that FIG. 6 is a perspective schematically view showing the inside of the vehicle 1 as viewed from the left direction. Also in the figure, portions corresponding to those of FIG. 5 are denoted by the same reference numerals.

In the example of FIG. 6, compared to the example of FIG. 5, a speaker 203FLU (not shown), a speaker 203FRU, a speaker 203FLD (not shown), a speaker 203FRD, a speaker 203BLD (not shown), and a speaker 203BRD are added.

The speaker 203FRU is arranged near the upper right end of the windshield of the vehicle 1 at a position higher than that of the speaker 203FR, and the speaker 203FRD is arranged below the speaker 203FR near the lower end of the door of the driver's seat. The speaker 203BRD is arranged below the speaker 203BR near the lower end of the door of the right-side backseat.

It is noted that although not shown in the figure, the speaker 203FLU, the speaker 203FLD, and the speaker 203BLD are arranged at positions substantially opposing the speaker 203FRU, the speaker 203FRD, and the speaker 203BRD on the left side of the interior.

The speaker 203FLU, the speaker 203FRU, the speaker 203FLD, the speaker 203FRD, the speaker 203BLD, and the speaker 203BRD are all installed to face the inside of the vehicle 1.

For example, by outputting sounds from the speaker 203FRU and the speaker 203FR, it is possible to localize a sound image at a position higher than the vehicle 1 (or the driver D1). Also, by outputting sounds from the speaker 203FRU and the speaker 203FR, it is possible to localize a sound image at a position lower than the vehicle 1 (or the driver D1).

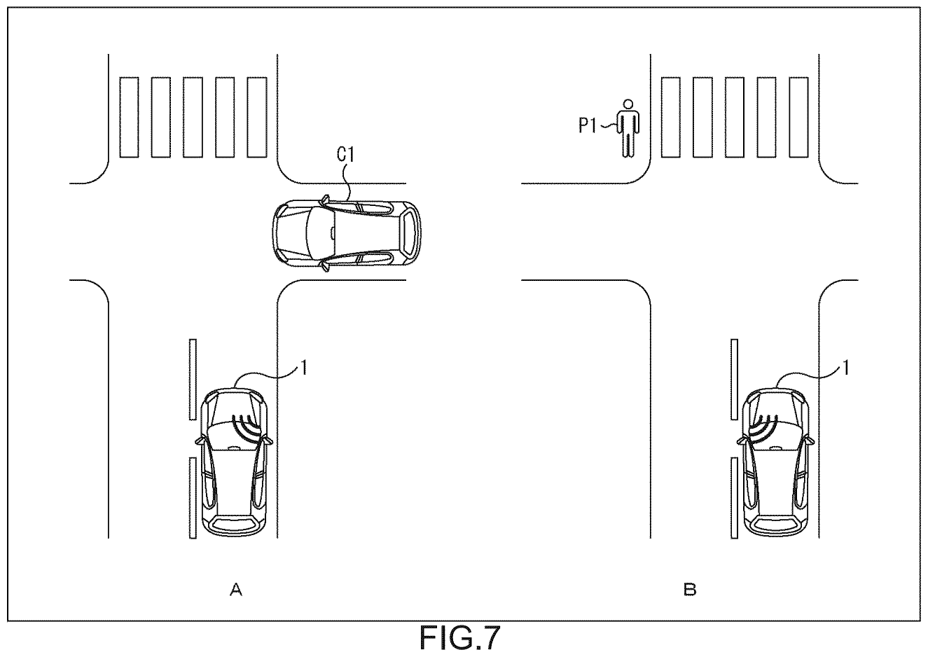

FIG. 7 is a diagram showing examples of outputting the notification sound.

When a vehicle Cl is present at the front right of the vehicle 1 as shown in A of FIG. 7, a notification sound is output such that, for example, a sound emitted from the vehicle 1 can be heard from a direction of the vehicle 1 (front right direction).

Further, when a pedestrian P1 is present at the front left of the vehicle 1, as shown in B of FIG. 7, a notification sound is output such that, for example, a sound emitted from the pedestrian P1 can be heard from a direction of the pedestrian P1 (front left direction).

In this manner, the sound generation unit 213 generates audio data to be supplied to each speaker of the sound presenting unit 203 so that the sound image of the notification sound for notifying of an object present around the vehicle 1 is localized at a position corresponding to the direction of the corresponding object using the vehicle 1 as a reference.

Since the sound emitted from the object or the sound evoking the type of object is output so as to be heard from the direction of the object, the user of the vehicle 1 can intuitively grasp what type of object is approaching the vehicle 1 from which direction.

It is noted that a feature amount of the notification sound may be controlled based on a distance between the vehicle 1 and the object. For example, when the object is present at a position distant from the vehicle 1, a notification sound from which high note components have been cut is output, or the pitch of the notification sound is raised.

A position of the sound image of the notification sound in a height direction (vertical direction) may be controlled based on the distance between the vehicle 1 and the object. For example, when an object is present at a position distant from the vehicle 1, the sound image of the notification sound is localized at a position higher than a reference position, and when the distance between the vehicle 1 and the object is a medium level, the sound image of the notification sound is localized at the reference position. When an object is present at a position close to the vehicle 1, the sound image of the notification sound is localized at a position lower than the reference position.

The position of the sound image of the notification sound in the height direction may be controlled based on the degree of danger of the object.

The position of the sound image of the notification sound may be controlled based on the prediction result of the future movement of the object (movement information). For example, a “whoosh” sound is output as the notification sound so that the position of the sound image moves along the trajectory along which the object is predicted to move.

The feature amount of the notification sound may be controlled based on a fluctuation of the degree of danger. For example, when the fluctuation of the degree of danger is large (when the accuracy of the prediction result of the movement of the object is low), reverb processing or echo processing for reproducing a sound reverberation in a cave or the like is applied to the notification sound.

As described above, in the present technology, the movement information indicating the future movement of the object around the vehicle 1 is predicted, the degree of danger of the object is calculated based on the movement information, and the feature amount of the notification sound that is presented to the user of the vehicle 1 and that corresponds to the type of object is controlled based on the degree of danger. The feature amount of the notification sound includes a volume, a frequency component, a pitch, an effect (for example, reverb or echo), and the like.

The vehicle control system 11 does not simply warn that a dangerous object is present around the vehicle 1, but presents a notification sound so that the user of the vehicle 1 can grasp the degree of danger of the object, the type of the object, and the direction of the object. Therefore, the vehicle control system 11 can favorably present information for avoiding danger to the user of the vehicle 1. This allows the user of the vehicle 1 to intuitively grasp the potential danger, and thus the vehicle control system 11 can realize safe traveling of the vehicle 1.

### 3. Modified Examples

### Example of Only Presenting Notification Sound to Driver

The sound generation unit 213 can also use audio signal processing technology to generate audio data so that the notification sound can only be heard by the driver of the vehicle 1. In this case, a user who is not engaged in driving and is sitting in the passenger's seat or the backseat does not hear the notification sound, so it becomes possible to realize a comfortable vehicle interior space for the user not engaged in driving.

Example of Presenting Notification Sound for Notify of Object that is not Seen from Vehicle 1

When information related to an object around the vehicle 1 can be obtained from equipment other than the vehicle 1, a notification sound for notifying of an object that is present at a position that is not actually seen from the vehicle 1 may be presented. For example, when another vehicle is predicted to suddenly appear in front of the vehicle 1 at an intersection with poor visibility, a sound emitted from the vehicle or a sound that evokes the vehicle is output so that it can be heard from the direction of the vehicle.

### Example of Noise Canceling

Depending on the traveling environment of the vehicle 1, the user inside the vehicle may be able to hear external sounds. For example, when the vehicle 1 is traveling near a construction site, the user inside the vehicle may be able to hear the sounds of the construction. In this case, the notification sound presented by the vehicle control system 11 will be mixed up with the external sounds to make it difficult for the user of the vehicle 1 to hear the notification sound.

In this regard, a notification sound for notifying of an object with a high degree of danger may be presented after performing noise canceling on the external sounds. It is noted that, when it is difficult to perform noise canceling, a volume of the notification sound may be raised such that the notification sound has a higher volume than the external sounds, and the higher-volume notification sound may be presented.

### Example of Linking Notification Sound and Visual Information

The vehicle control system 11 is also capable of presenting the notification sound in conjunction with visual information indicating a degree of danger of an object around the vehicle 1.

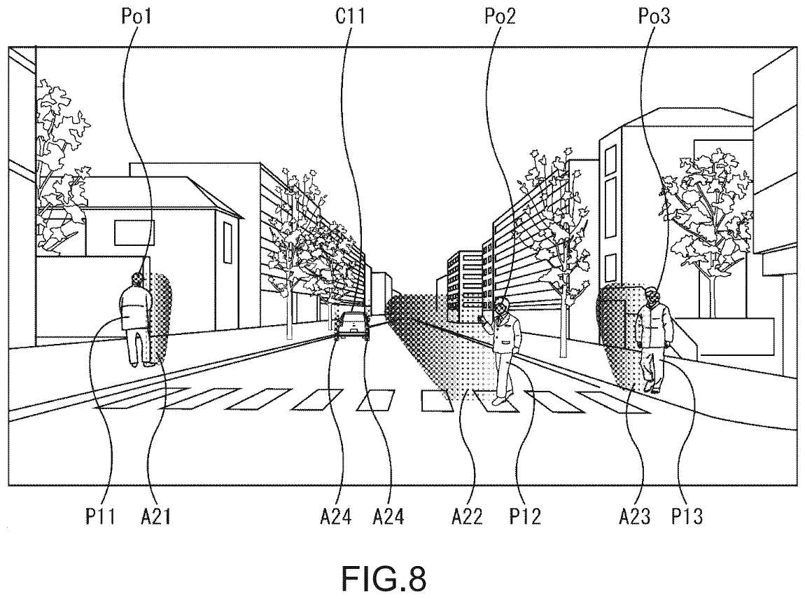

FIG. 8 is a diagram showing an example of the visual information.

In the example shown in FIG. 8, pieces of danger prediction information A21 to A24 each indicating a degree of danger of an object around the vehicle 1 are displayed in a state of being superimposed on a captured video showing the surroundings of the vehicle 1.

For example, the danger prediction information A21 indicates the degree of danger of a pedestrian P11 moving in the rear direction as viewed from the user of the vehicle 1 by the color, and indicates a range that the pedestrian P11 is predicted to move by the shape. The danger prediction information A22 indicates the degree of danger of a pedestrian P12 crossing a crosswalk by the color, and indicates a range that the pedestrian P12 is predicted to move by the shape. The danger prediction information A23 indicates the degree of danger of a pedestrian P13 who is about to cross the crosswalk by the color, and indicates a range that the pedestrian P13 is predicted to move by the shape. The danger prediction information A24 indicates the degree of danger of a vehicle C11 stopped on the road by the color.

Points Po1 to Po3 are displayed in a state of being respectively superimposed on the heads of the pedestrians P11 to P13.

The captured video on which the pieces of danger prediction information A21 to A24 and the points Po to Po3 are superimposed is displayed, for example, on a display mounted inside the vehicle 1. By presenting a notification sound in conjunction with the captured video and the danger prediction information displayed on the display, the user of the vehicle 1 can easily grasp a generation source of the notification sound.

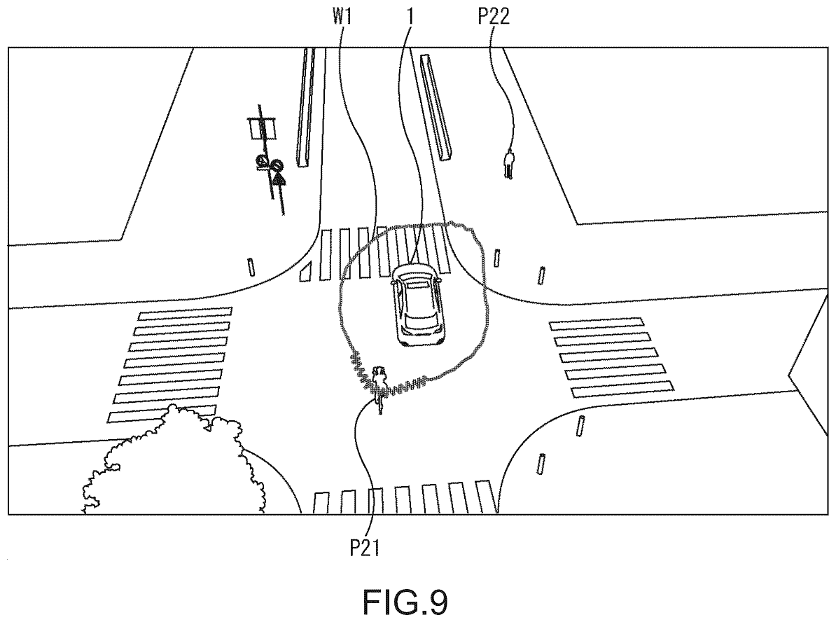

FIG. 9 is a diagram showing another example of the visual information.

In the example shown in FIG. 9, a CG (Computer Graphics) video in which the vehicle 1 itself and objects and environment around the vehicle 1 are reproduced is displayed. The CG video includes a waveform W1 that indicates a direction from which the notification sound is heard and a volume of the notification sound (degree of danger). The waveform W1 is a circular line that surrounds the vehicle 1, and a portion of the line that corresponds to the direction from which the notification sound is heard is displayed in a wavy line. The louder the notification sound is, the larger the wave of the portion of the waveform W1 that corresponds to the direction from which the notification sound is heard becomes.

For example, as shown in FIG. 9, when a person P21 riding a bicycle is present at the rear left of the vehicle 1, a notification sound for notifying of the person P21 (bicycle) is presented at a high volume, so the wave of the portion of the waveform W1 that corresponds to the direction of the person P21 using the vehicle 1 as a reference becomes large.

Also, as shown in FIG. 9, when a pedestrian P22 is present at the front right of the vehicle 1, a notification sound for notifying of the pedestrian P22 is presented at a low volume, so the wave of the portion of the waveform W1 that corresponds to the direction of the pedestrian P22 using the vehicle 1 as a reference becomes small.

It is noted that in the waveform W1, the portion corresponding to the direction of each object using the vehicle 1 as a reference is displayed in, for example, orange, and the other portion is displayed in, for example, cyan. The color of the portion of the waveform W1 corresponding to the direction of each object using the vehicle 1 as a reference may be determined based on the degree of danger of each object.

In this manner, by presenting the notification sound in conjunction with the CG video including the waveform W1 indicating the direction from which the notification sound is heard and the volume of the notification sound (degree of danger), it becomes easier for the user of the vehicle 1 to grasp the generation source of the notification sound.

### Others

The present technology can be applied to various products. For example, the present technology may be realized as a device mounted on any type of moving body such as an automobile, an electric vehicle, a hybrid electric vehicle, a motorcycle, a bicycle, a personal mobility, an airplane, a drone, a ship, or a robot.

### Regarding Computer

The series of processing described above can be executed by hardware or can be executed by software. When the series of processing is executed by software, a program configuring the software is installed in a computer incorporated into dedicated hardware, a general-purpose personal computer, and/or the like from a medium having the program recorded thereon.

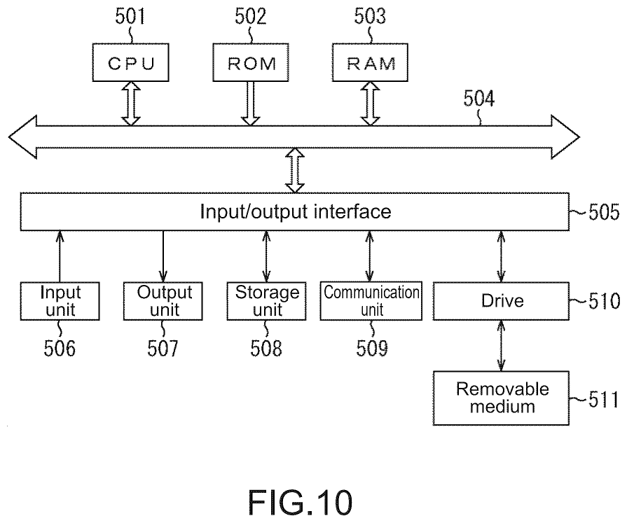

FIG. 10 is a block diagram showing a hardware configuration example of a computer that executes the series of processing described above by a program. The information processing unit 201 includes, for example, a PC having a configuration similar to the configuration shown in FIG. 10.

A CPU 501, a ROM (Read Only Memory) 502, and a RAM 503 are mutually connected via a bus 504.

An input/output interface 505 is also connected to the bus 504. Connected to the input/output interface 505 are an input unit 506 that includes a keyboard, a mouse, and/or the like and an output unit 507 that includes a display, a speaker, and/or the like. Also connected to the input/output interface 505 are a storage unit 508 that includes a hard disk, a nonvolatile memory, and/or the like, a communication unit 509 that includes a network interface and/or the like, and a drive 510 that drives a removable medium 511.

In the computer configured as described above, the CPU 501 loads a program stored in the storage unit 508 into the RAM 503 via the input/output interface 505 and the bus 504 and executes it, to carry out the series of processing described above, for example.

The program to be executed by the CPU 501 is, for example, recorded onto the removable medium 511 or is provided via wired or wireless transmission media such as a local area network, the Internet, and digital broadcasting, to be installed in the storage unit 508.

It is noted that the program to be executed by the computer may be a program in which the processing is executed in time series in the order described in the present specification, or may be a program in which the processing is executed in parallel or at necessary timings such as when invoked.

In the present specification, the system refers to an aggregation of a plurality of constituent elements (apparatuses, modules (components), and the like), and whether all of the constituent elements are within the same housing is irrelevant. Accordingly, a plurality of apparatuses respectively housed in separate housings and connected to each other via a network and a single apparatus in which a plurality of modules is housed in a single housing are both systems.

The effects described in the present specification are mere examples and are not limited, and other effects may also be exerted.

Further, the embodiment of the present technology is not limited to the embodiment described above and can be variously modified without departing from the gist of the present technology.

For example, the present technology can take a configuration of cloud computing in which a single function is shared to be cooperatively processed by a plurality of apparatuses via a network.

Moreover, the respective steps described above in the flowchart can be executed by a single apparatus, or can be shared by a plurality of apparatuses to be executed.

In addition, when a plurality of processing is included in a single step, the plurality of processing included in that single step can be executed by a single apparatus, or can be shared by a plurality of apparatuses to be executed.

### Combination Example of Configurations

The present technology can also take the following configurations.
(1) An information processing apparatus, including:
   a prediction unit which predicts movement information indicating a future movement of an object around a moving body;
   a calculation unit which calculates a degree of danger of the object on the basis of the movement information; and
   a presentation control unit which controls, on the basis of the degree of danger, a notification sound that is presented to a user of the moving body and that corresponds to a type of the object.
(2) The information processing apparatus according to (1), in which
   the notification sound includes a sound emitted from the object.
(3) The information processing apparatus according to (1) or (2), in which
   the notification sound includes a sound that evokes the type of the object.
(4) The information processing apparatus according to (3), in which
   the presentation control unit generates the sound evoking the type of the object, on the basis of a sound provided in advance.
(5) The information processing apparatus according to any one of (1) to (4), in which
   the presentation control unit controls a volume of the notification sound on the basis of the degree of danger.
(6) The information processing apparatus according to (5), in which
   the presentation control unit
      presents, at a volume lower than a reference volume, the notification sound corresponding to the type of the object having the degree of danger having a value smaller than a first threshold value, and
      presents, at a volume higher than the reference volume, the notification sound corresponding to the type of the object having the degree of danger having a value larger than the first threshold value.
(7) The information processing apparatus according to any one of (1) to (6), in which
   when the degree of danger has a value larger than a second threshold value, the presentation control unit presents the notification sound including a warning sound.
(8) The information processing apparatus according to any one of (1) to (7), in which
   the presentation control unit controls a position of a sound image of the notification sound on the basis of a position of the object.
(9) The information processing apparatus according to (8), in which
   the presentation control unit localizes the sound image at a position corresponding to a direction of the object that is determined using the moving body as a reference.
(10) The information processing apparatus according to (9), in which
   the presentation control unit further presents visual information indicating the degree of danger.
(11) The information processing apparatus according to (10), in which
   the presentation control unit presents, as the visual information, a CG video that includes a waveform indicating the position of the sound image of the notification sound and a volume of the notification sound and that shows the object around the moving body.
(12) The information processing apparatus according to any one of (8) to (11), in which
   the presentation control unit moves the position of the sound image along a trajectory along which the object is predicted to move.
(13) The information processing apparatus according to any one of (8) to (12), in which
   the presentation control unit controls the position of the sound image in a height direction on the basis of a distance between the moving body and the object.
(14) The information processing apparatus according to any one of (1) to (13), in which
   the presentation control unit only presents the notification sound to a driver of the moving body.
(15) The information processing apparatus according to any one of (1) to (14), in which
   the presentation control unit performs noise canceling with respect to an external sound.
(16) The information processing apparatus according to any one of (1) to (15), in which
   the prediction unit further predicts accident information indicating a movement of the object in a case where an accident occurs, and
   the calculation unit calculates the degree of danger on the basis of the movement information and the accident information.
(17) The information processing apparatus according to (16), in which
   the presentation control unit controls an effect of the notification sound on the basis of a fluctuation of the degree of danger.
(18) An information processing method that is performed by an information processing apparatus, the information processing method including:
   predicting movement information indicating a future movement of an object around a moving body;
   calculating a degree of danger of the object on the basis of the movement information; and
   controlling, on the basis of the degree of danger, a notification sound that is presented to a user of the moving body and that corresponds to a type of the object.
(19) A program for causing a computer to execute processing including:
   predicting movement information indicating a future movement of an object around a moving body;
   calculating a degree of danger of the object on the basis of the movement information; and
   controlling, on the basis of the degree of danger, a notification sound that is presented to a user of the moving body and that corresponds to a type of the object.

### REFERENCE SIGNS LIST

1 vehicle
11 vehicle control system
25 external recognition sensor
73 recognition unit
201 information processing unit
202 sound material database
203 sound presenting unit
211 prediction unit
212 degree-of-danger calculation unit
213 sound generation unit

1. An information processing apparatus, comprising:
a prediction unit which predicts movement information indicating a future movement of an object around a moving body;
a calculation unit which calculates a degree of danger of the object on a basis of the movement information; and
a presentation control unit which controls, on a basis of the degree of danger, a notification sound that is presented to a user of the moving body and that corresponds to a type of the object.

2. The information processing apparatus according to claim 1, wherein
the notification sound includes a sound emitted from the object.

3. The information processing apparatus according to claim 1, wherein
the notification sound includes a sound that evokes the type of the object.

4. The information processing apparatus according to claim 3, wherein
the presentation control unit generates the sound evoking the type of the object, on a basis of a sound provided in advance.

5. The information processing apparatus according to claim 1, wherein
the presentation control unit controls a volume of the notification sound on the basis of the degree of danger.

6. The information processing apparatus according to claim 5, wherein
the presentation control unit
presents, at a volume lower than a reference volume, the notification sound corresponding to the type of the object having the degree of danger having a value smaller than a first threshold value, and
presents, at a volume higher than the reference volume, the notification sound corresponding to the type of the object having the degree of danger having a value larger than the first threshold value.

7. The information processing apparatus according to claim 1, wherein
when the degree of danger has a value larger than a second threshold value, the presentation control unit presents the notification sound including a warning sound.

8. The information processing apparatus according to claim 1, wherein
the presentation control unit controls a position of a sound image of the notification sound on a basis of a position of the object.

9. The information processing apparatus according to claim 8, wherein
the presentation control unit localizes the sound image at a position corresponding to a direction of the object that is determined using the moving body as a reference.

10. The information processing apparatus according to claim 9, wherein
the presentation control unit further presents visual information indicating the degree of danger.

11. The information processing apparatus according to claim 10, wherein
the presentation control unit presents, as the visual information, a CG video that includes a waveform indicating the position of the sound image of the notification sound and a volume of the notification sound and that shows the object around the moving body.

12. The information processing apparatus according to claim 8, wherein
the presentation control unit moves the position of the sound image along a trajectory along which the object is predicted to move.

13. The information processing apparatus according to claim 8, wherein
the presentation control unit controls the position of the sound image in a height direction on a basis of a distance between the moving body and the object.

14. The information processing apparatus according to claim 1, wherein
the presentation control unit only presents the notification sound to a driver of the moving body.

15. The information processing apparatus according to claim 1, wherein
the presentation control unit performs noise canceling with respect to an external sound.

16. The information processing apparatus according to claim 1, wherein
the prediction unit further predicts accident information indicating a movement of the object in a case where an accident occurs, and
the calculation unit calculates the degree of danger on a basis of the movement information and the accident information.

17. The information processing apparatus according to claim 16, wherein
the presentation control unit controls an effect of the notification sound on a basis of a fluctuation of the degree of danger.

18. An information processing method that is performed by an information processing apparatus, the information processing method comprising:
predicting movement information indicating a future movement of an object around a moving body;
calculating a degree of danger of the object on a basis of the movement information; and
controlling, on a basis of the degree of danger, a notification sound that is presented to a user of the moving body and that corresponds to a type of the object.

19. A program for causing a computer to execute processing comprising:
predicting movement information indicating a future movement of an object around a moving body;
calculating a degree of danger of the object on a basis of the movement information; and
controlling, on a basis of the degree of danger, a notification sound that is presented to a user of the moving body and that corresponds to a type of the object.
